(19) United States
(12) Patent Application Publication
(10) Pub. No.: US 2026/0370440 A1
(43) Pub. Date: Nov. 19, 2026

(54) SWITCHING PATTERN FOR SIGNAL RECEPTION

(71) Applicant: QUALCOMM Incorporated, San Diego, CA (US)

(72) Inventors: Jae Ho RYU, San Diego, CA (US); Kazuki TAKEDA, Minato-ku (JP); Hari SANKAR, Poway, CA (US)

(21) Appl. No.: 19/375,058

(22) Filed: Oct. 30, 2025

Related U.S. Application Data
(60) Provisional application No. 63/778,036, filed on Mar. 26, 2025.

(51) Int. Cl. H04L 5/14; H04B 7/06; H04L 5/00; H04W 76/20

(52) U.S. Cl. CPC H04L 5/14; H04B 7/06968; H04L 5/0044; H04W 76/20

(57) ABSTRACT

Various aspects of the present disclosure generally relate to wireless communication. In some aspects, a user equipment (UE) may receive a first configuration to operate in a first mode for transmission and reception in a frequency division duplex (FDD) band during a first time period. The UE may receive a second configuration to operate in a second mode for reception in a supplementary downlink band during a second time period, where reception in the FDD band is allowed or dropped during the second time period based at least in part on a rule. The UE may receive an indication of a semi-static switching pattern that defines transition between the first mode and the second mode. The UE may receive downlink signals according to the rule and the semi-static switching pattern. Numerous other aspects are described.

### CROSS-REFERENCE TO RELATED APPLICATION

This Patent Application claims priority to U.S. Provisional Patent Application No. 63/778,036, filed on Mar. 26, 2025, entitled “SWITCHING PATTERN FOR SIGNAL RECEPTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with switching patterns for signal reception.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

FIG. 1 is a diagram illustrating an example of a wireless communication network.

FIG. 2 is a diagram illustrating examples of carrier aggregation.

FIG. 3 is a diagram illustrating an example of a transceiver that can switch bands.

FIG. 4 is a diagram illustrating an example of different modes.

FIG. 5 is a diagram illustrating an example of using a switching pattern.

FIG. 6 is a diagram illustrating an example of using a non-staggered configuration.

FIG. 7 is a diagram illustrating an example of a first option for a non-staggered periodic signal/channel configuration.

FIG. 8 is a diagram illustrating an example of a second option for a non-staggered periodic signal/channel configuration.

FIG. 9 is a diagram illustrating an example of a third option for a non-staggered periodic signal/channel configuration.

FIG. 10 is a diagram illustrating an example associated with using a switching pattern.

FIG. 11 is a diagram illustrating an example process performed, for example, at a user equipment (UE) or an apparatus of a UE.

FIG. 12 is a diagram illustrating an example process performed, for example, at a network entity or an apparatus of a network entity.

FIG. 13 is a diagram of an example apparatus for wireless communication.

FIG. 14 is a diagram of an example apparatus for wireless communication.

### SUMMARY

Some aspects described herein relate to a method of wireless communication performed by a user equipment (UE). The method may include receiving a first configuration to operate in a first mode for transmission and reception in a frequency division duplex (FDD) band during a first time period. The method may include receiving a second configuration to operate in a second mode for reception in a supplementary downlink band during a second time period, where reception in the FDD band is allowed or dropped during the second time period based at least in part on a rule. The method may include receiving an indication of a semi-static switching pattern that defines transition between the first mode and the second mode. The method may include receiving downlink signals according to the rule and the semi-static switching pattern.

Some aspects described herein relate to a method of wireless communication performed by a network entity. The method may include transmitting a first configuration for a UE to operate in a first mode for transmission and reception in FDD band during a first time period. The method may include transmitting a second configuration for the UE to operate in a second mode for reception in a supplementary downlink band during a second time period, where reception by the UE in the FDD band is allowed or dropped during the second time period based at least in part on a rule. The method may include transmitting an indication of a semi-static switching pattern that defines transition between the first mode and the second mode. The method may include transmitting downlink signals according to the rule and the semi-static switching pattern.

Some aspects described herein relate to a UE. The UE may include a processing system. The processing system may include one or more processors and one or more code-storing memories coupled with the one or more processors. The processing system may be configured to cause the UE to receive a first configuration to operate in a first mode for transmission and reception in FDD band during a first time period. The processing system may be configured to cause the UE to receive a second configuration to operate in a second mode for reception in a supplementary downlink band during a second time period, where reception in the FDD band is allowed or dropped during the second time period based at least in part on a rule. The processing system may be configured to cause the UE to receive an indication of a semi-static switching pattern that defines transition between the first mode and the second mode. The processing system may be configured to cause the UE to receive downlink signals according to the rule and the semi-static switching pattern.

Some aspects described herein relate to a network entity. The network entity may include a processing system. The processing system may include one or more processors and one or more code-storing memories coupled with the one or more processors. The processing system may be configured to cause the network entity to transmit a first configuration for a UE to operate in a first mode for transmission and reception in FDD band during a first time period. The processing system may be configured to cause the network entity to transmit a second configuration for the UE to operate in a second mode for reception in a supplementary downlink band during a second time period, where reception by the UE in the FDD band is allowed or dropped during the second time period based at least in part on a rule. The processing system may be configured to cause the network entity to transmit an indication of a semi-static switching pattern that defines transition between the first mode and the second mode. The processing system may be configured to cause the network entity to transmit downlink signals according to the rule and the semi-static switching pattern.

Some aspects described herein relate to a non-transitory computer-readable medium that stores a set of instructions for wireless communication by a UE. The set of instructions, when executed by one or more processors of the UE, may cause the UE to receive a first configuration to operate in a first mode for transmission and reception in FDD band during a first time period. The set of instructions, when executed by one or more processors of the UE, may cause the UE to receive a second configuration to operate in a second mode for reception in a supplementary downlink band during a second time period, where reception in the FDD band is allowed or dropped during the second time period based at least in part on a rule. The set of instructions, when executed by one or more processors of the UE, may cause the UE to receive an indication of a semi-static switching pattern that defines transition between the first mode and the second mode. The set of instructions, when executed by one or more processors of the UE, may cause the UE to receive downlink signals according to the rule and the semi-static switching pattern.

Some aspects described herein relate to a non-transitory computer-readable medium that stores a set of instructions for wireless communication by a network entity. The set of instructions, when executed by one or more processors of the network entity, may cause the network entity to transmit a first configuration for a UE to operate in a first mode for transmission and reception in FDD band during a first time period. The set of instructions, when executed by one or more processors of the network entity, may cause the network entity to transmit a second configuration for the UE to operate in a second mode for reception in a supplementary downlink band during a second time period, where reception by the UE in the FDD band is allowed or dropped during the second time period based at least in part on a rule. The set of instructions, when executed by one or more processors of the network entity, may cause the network entity to transmit an indication of a semi-static switching pattern that defines transition between the first mode and the second mode. The set of instructions, when executed by one or more processors of the network entity, may cause the network entity to transmit downlink signals according to the rule and the semi-static switching pattern.

Some aspects described herein relate to an apparatus for wireless communication. The apparatus may include means for receiving a first configuration to operate in a first mode for transmission and reception in FDD band during a first time period. The apparatus may include means for receiving a second configuration to operate in a second mode for reception in a supplementary downlink band during a second time period, where reception in the FDD band is allowed or dropped during the second time period based at least in part on a rule. The apparatus may include means for receiving an indication of a semi-static switching pattern that defines transition between the first mode and the second mode. The apparatus may include means for receiving downlink signals according to the rule and the semi-static switching pattern.

Some aspects described herein relate to an apparatus for wireless communication. The apparatus may include means for transmitting a first configuration for another apparatus to operate in a first mode for transmission and reception in FDD band during a first time period. The apparatus may include means for transmitting a second configuration for the other apparatus to operate in a second mode for reception in a supplementary downlink band during a second time period, where reception by the other apparatus in the FDD band is allowed or dropped during the second time period based at least in part on a rule. The apparatus may include means for transmitting an indication of a semi-static switching pattern that defines transition between the first mode and the second mode. The apparatus may include means for transmitting downlink signals according to the rule and the semi-static switching pattern.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### DETAILED DESCRIPTION

In wireless communication systems, carrier aggregation (CA) is a technique that allows a user equipment (UE) to use multiple carriers (component carriers) simultaneously to increase the bandwidth and consequently the data rate of a transmission. When low-band frequencies are aggregated with other low-band frequencies, as in low band-low band (LB-LB) CA, the network can utilize more of the available spectrum for faster data rates while still maintaining the benefits of coverage and range that low-band frequencies provide. The low-band frequencies may be sub-1 GHz frequencies, which are known for their coverage and range. The introduction LB-LB CA, where both the primary cell (PCell) and secondary cell (SCell) operate in low frequency bands, presents several technical challenges in the implementation of carrier switching based on radio resource control (RRC) configurations.

One primary challenge arises from the hardware limitations of UEs, which may not have separate antennas for each band due to size, cost, or design constraints. Instead, a shared antenna system is often used, necessitating the need for the UE to switch between different frequency bands. This switching is not instantaneous and introduces a delay, which can vary depending on the UE's capability. During this delay, the UE may not be able to transmit or receive signals, leading to dropped communications if scheduled by the network entity.

Additionally, for semi-static switching patterns where the UE toggles between different operational modes (e.g., Tx/Rx on a frequency division duplex (FDD) band PCell and Rx on a supplementary downlink (SDL) band SCell) based on predefined time periods (e.g., T1 and T2), a semi-static pattern may not align with the periodic signals and channels that UEs are required to receive or measure, such as synchronization signal blocks (SSBs), tracking reference signals (TRSs), and channel state information reference signals (CSI-RSs). The misalignment between the semi-static switching pattern and the periodic reception of these signals can lead to a scenario where the UE needs to receive or measure signals in a band to which the UE is not currently tuned, according to the switching pattern.

Various aspects relate generally to improved wireless communication management in systems utilizing LB-LB CA with Rx switching. Some aspects more specifically relate to a UE that operates based on received configurations for different modes of operation corresponding to transmission and reception in an FDD band and reception in an SDL band during designated time periods. The UE may receive an indication of a semi-static switching pattern that governs transitions between these operational modes. The UE may process downlink signals according to a specified rule and the semi-static switching pattern. The rule may specify how the UE is to receive downlink signals with the switching pattern in the context of the signals in each mode.

In some aspects, the semi-static switching pattern may be determined by an RRC configuration, and the UE may receive configurations for handling periodic downlink signals such as SSBs, TRSs, CSI-RSs, or semi-persistent physical downlink shared channels (SP-PDSCHs). The rule may specify whether periodic downlink signals for the SDL band should be aligned with the semi-static switching pattern or if the signals are allowed to be non-aligned, with potential reception of SDL band signals during periods designated for FDD band operation.

Particular aspects of the subject matter described in this disclosure can be implemented to realize one or more of the following potential advantages. The UE's capability to adapt to the semi-static switching pattern for the reception of periodic downlink signals for different modes aligns with the network's scheduling constraints, thereby optimizing the utilization of radio resources.

In some aspects, the UE's capability to switch to the SDL band for signal reception or measurement without interrupting the semi-static switching pattern potentially conserves processing resources and memory resources by avoiding unnecessary signal reception attempts during non-designated periods. Additionally, network-directed control of SP-PDSCH reception can prevent scheduling conflicts and enhance the efficiency of resource allocation, which may contribute to improved network capacity and conservation of network resources.

Overall, advantages may include enhanced radio resource management, prevention of scheduling conflicts, and improved network capacity through controlled UE behavior in LB-LB CA systems with Rx switching. This approach conserves processing resources, memory resources, and network resources, contributing to a more efficient wireless communication system.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

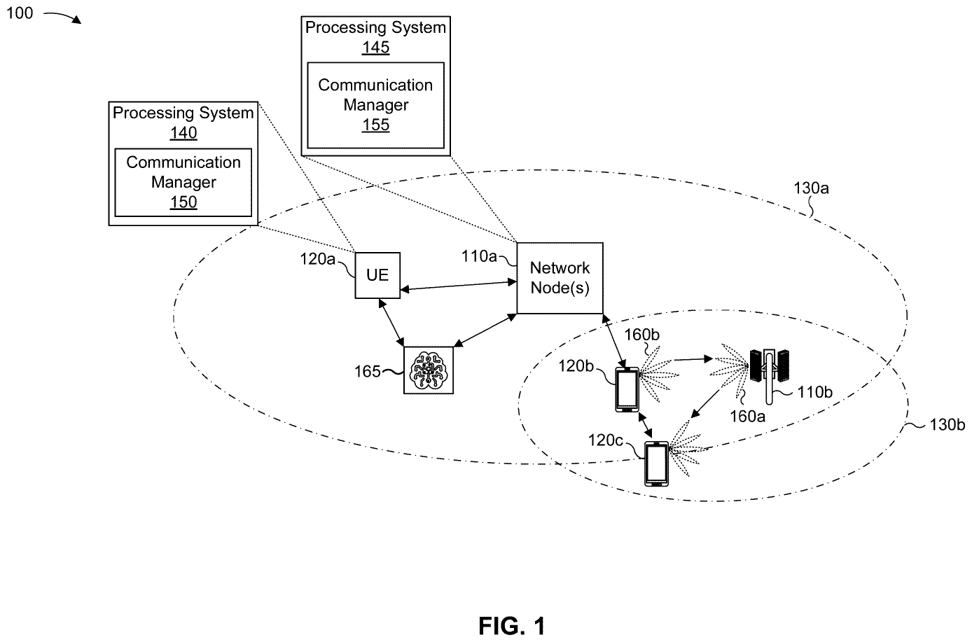

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive a first configuration to operate in a first mode for transmission and reception in FDD band during a first time period; receive a second configuration to operate in a second mode for reception in a supplementary downlink band during a second time period, where reception in the FDD band is allowed or dropped during the second time period based at least in part on a rule; receive an indication of a semi-static switching pattern that defines transition between the first mode and the second mode; and receive downlink signals according to the rule and the semi-static switching pattern. Additionally, or alternatively, the communication manager 150 may perform one or more other operations described herein.

In some aspects, a network entity (e.g., network node 110) may include a communication manager 155. As described in more detail elsewhere herein, the communication manager 155 may transmit a first configuration for a UE to operate in a first mode for transmission and reception in FDD band during a first time period; transmit a second configuration for the UE to operate in a second mode for reception in a supplementary downlink band during a second time period, where reception by the UE in the FDD band is allowed or dropped during the second time period based at least in part on a rule; transmit an indication of a semi-static switching pattern that defines transition between the first mode and the second mode; and transmit downlink signals according to the rule and the semi-static switching pattern. Additionally, or alternatively, the communication manager 155 may perform one or more other operations described herein.

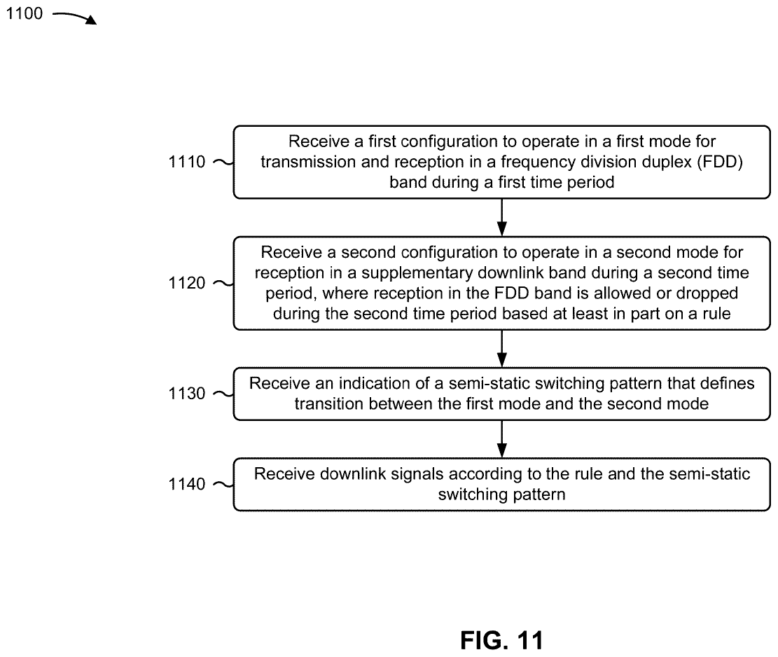

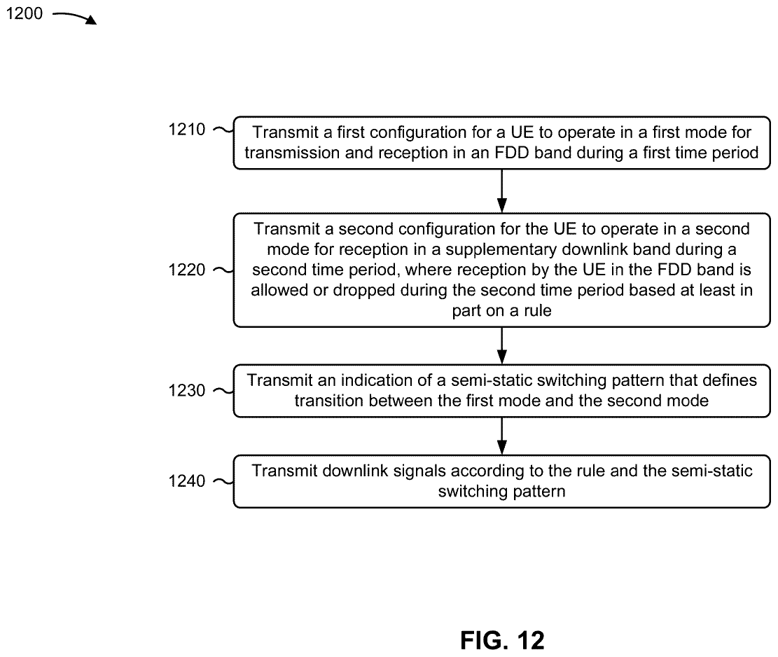

The network node 110, the processing system 145 of the network node 110, the UE 120, the processing system 140 of the UE 120, or any other component(s) of FIG. 1 may implement one or more techniques or perform one or more operations associated with using a switching pattern for signal reception, as described in more detail elsewhere herein. For example, the processing system 145 of the network node 110, or the processing system 140 of the UE 120 may perform or direct operations of, for example, process 1100 of FIG. 11, process 1200 of FIG. 12 or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

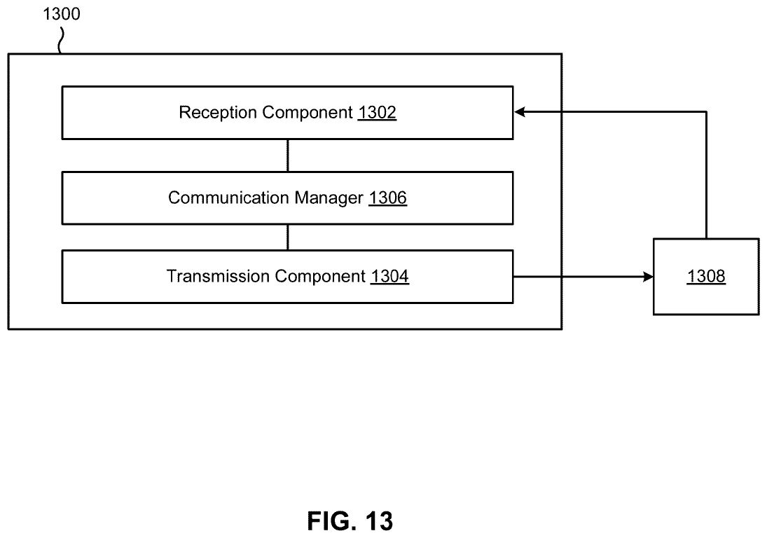

In some aspects, the UE 120 includes means for receiving a first configuration to operate in a first mode for transmission and reception in FDD band during a first time period; means for receiving a second configuration to operate in a second mode for reception in a supplementary downlink band during a second time period, where reception in the FDD band is allowed or dropped during the second time period based at least in part on a rule; means for receiving an indication of a semi-static switching pattern that defines transition between the first mode and the second mode; or means for receiving downlink signals according to the rule and the semi-static switching pattern. The means for the UE to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

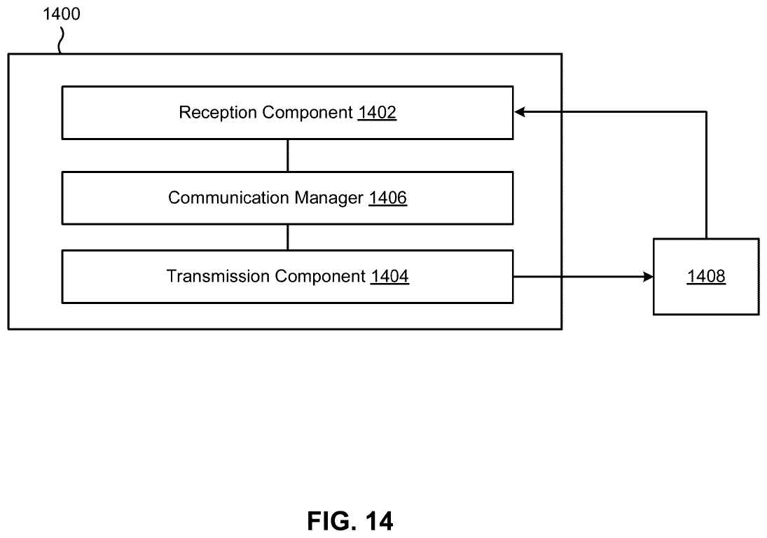

In some aspects, the network entity includes means for transmitting a first configuration for a UE to operate in a first mode for transmission and reception in FDD band during a first time period; means for transmitting a second configuration for the UE to operate in a second mode for reception in a supplementary downlink band during a second time period, where reception by the UE in the FDD band is allowed or dropped during the second time period based at least in part on a rule; means for transmitting an indication of a semi-static switching pattern that defines transition between the first mode and the second mode; or means for transmitting downlink signals according to the rule and the semi-static switching pattern. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

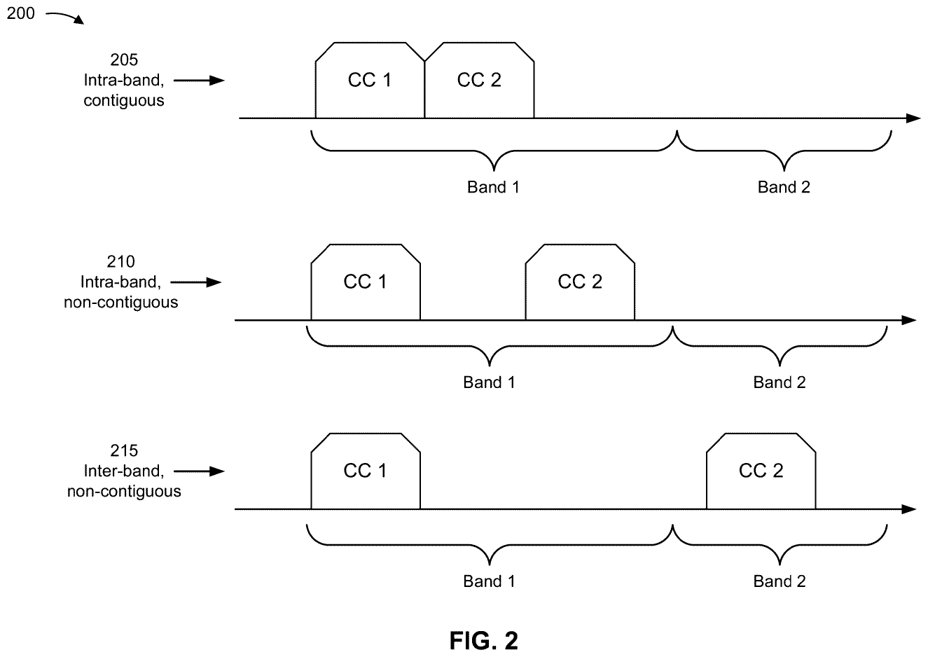

FIG. 2 is a diagram illustrating examples 200 of CA. CA is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network entity (e.g., a network node 110) may configure carrier aggregation for a UE 120, such as in an RRC message, DCI, or another signaling message.

As shown by reference number 205, in some aspects, CA may be configured in an intra-band contiguous mode where the aggregated carriers are contiguous to one another and are in the same band. As shown by reference number 210, in some aspects, CA may be configured in an intra-band non-contiguous mode where the aggregated carriers are non-contiguous to one another and are in the same band. As shown by reference number 215, in some aspects, CA may be configured in an inter-band non-contiguous mode where the aggregated carriers are non-contiguous to one another and are in different bands.

In CA, a UE 120 may be configured with a primary carrier or primary cell (PCell) and one or more secondary carriers or secondary cells (SCells). In some aspects, the primary carrier may carry control information (e.g., downlink control information or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

The introduction of LB-LB CA, where both the PCell and the SCell operate in low frequency bands, presents several technical challenges in the implementation of carrier switching based on RRC configurations. One primary challenge arises from the hardware limitations of UEs, which may not have separate antennas for each band due to size, cost, or design constraints. Instead, a shared antenna system is often used, necessitating the need for the UE to switch between different frequency bands. This switching is not instantaneous and introduces a delay, which can vary depending on the UE's capability. During this delay, the UE may not be able to transmit or receive signals, leading to dropped communications if scheduled by the network entity.

As indicated above, FIG. 2 is provided as an example. Other examples may differ from what is described with regard to FIG. 2.

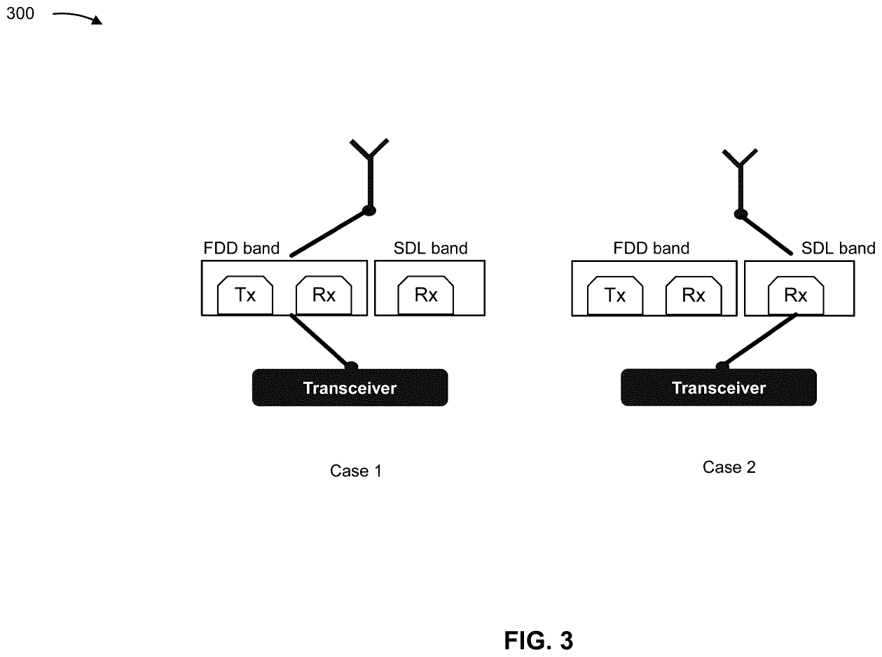

FIG. 3 is a diagram illustrating an example 300 of a transceiver that can switch bands. As shown by example 300, the transceiver may operate in different modes for communication in the FDD band and the SDL band. In some aspects, the transceiver may be configured to support transmission (Tx) and reception (Rx) in the FDD band, and Rx in the SDL band, according to a semi-static switching pattern. For example, the transceiver may be configured to handle both Tx and Rx in the FDD band, while only supporting Rx in the SDL band, based on a semi-static switching pattern. Additionally, or alternatively, the transceiver might be configured to enable Tx and Rx within the FDD band, and Rx within the SDL band, following a semi-static switching pattern. Additionally, or alternatively, the transceiver could be configured to facilitate Tx and Rx in the FDD band and Rx in the SDL band, in accordance with a semi-static switching pattern.

The transceiver may operate in a case 1 mode, where the transceiver is configured to transmit and receive in the FDD band while simultaneously receiving in the SDL band is not allowed. In some aspects, the transceiver could switch to a case 2 mode, where the transceiver exclusively receives in the SDL band and suspends transmission and reception in the FDD band. The transceiver could switch to the case 2 mode, where the transceiver solely receives in the SDL band and halts transmission and reception in the FDD band. Additionally, or alternatively, the transceiver might transition to the case 2 mode, dedicated to receiving in the SDL band while suspending all transmission and reception in the FDD band. Additionally, or alternatively, in the case 2 mode, the transceiver exclusively receives in the SDL band and ceases transmission and reception activities in the FDD band. This switching is governed by the semi-static switching pattern received from a network entity. This mode switching is regulated by a semi-static switching pattern provided by the network entity.

Additionally, or alternatively, the transition between modes is controlled by a semi-static switching pattern received from the network entity. Additionally, or alternatively, the semi-static switching pattern, obtained from a network entity, governs this mode switching. The transceiver's ability to switch between these modes allows the UE to align its operations with the periodic downlink signals, such as SSBs, TRSs, and CSI-RSs.

As indicated above, FIG. 3 is provided as an example. Other examples may differ from what is described with regard to FIG. 3.

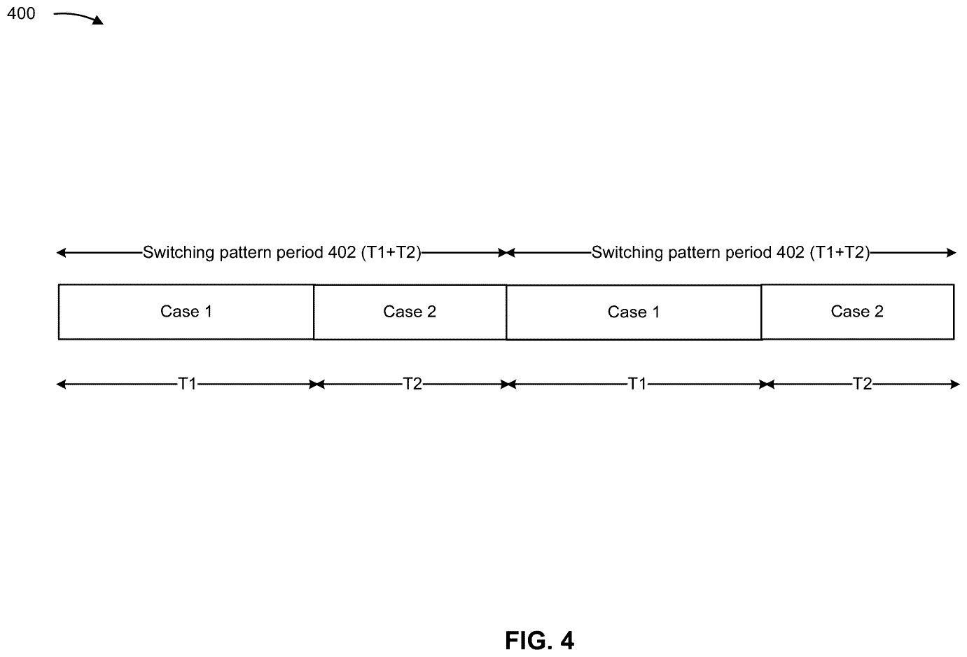

FIG. 4 is a diagram illustrating an example 400 of different modes. As shown by example 400, a switching pattern period 402 may be defined for a UE to operate in different modes during respective time periods. For example, the switching pattern period 402 may include a first time period (T1) and a second time period (T2).

In some aspects, the switching pattern period 402 may be defined, where the UE is configured to operate in a first mode during T1 and in a second mode during a T2. This configuration allows for distinct operational periods, optimizing the UE's functionality based on the network's requirements and the UE's capabilities. Additionally, or alternatively, during T1, the UE may operate in a first mode where the UE transmits and receives in FDD band. In contrast, during T2, the UE may switch to a second mode where the UE receives in the SDL band while transmissions and receptions in the FDD band are paused. This switching mechanism ensures efficient use of the available bandwidth and reduces interference between different frequency bands. Additionally, or alternatively, as depicted in FIG. 4, the switching pattern period 402 may periodically alternate between T1 and T2, facilitating transitions between the first mode and second mode based on semi-static switching patterns relayed by a network entity. This periodic alternation helps maintain a balanced communication load and enhances the overall network performance.

As further shown in FIG. 4, during T1, the UE may operate in the case 1 mode, where the UE is configured to transmit and receive in the FDD band. During T2, the UE may operate in the case 2 mode, where the UE is configured to receive in the SDL band, while transmission and reception in the FDD band are suspended. This switching pattern period 402 may repeat, defining transitions between the case 1 and case 2 modes based on the semi-static switching pattern received from a network entity.

According to various aspects described herein, the switching pattern may synchronize the UE's operations with periodic downlink signals such as SSBs, TRSs, and CSI-RSs. This synchronization ensures optimized performance of reception and transmission capabilities. Additionally, or alternatively, in one implementation, during T1, the UE may perform both transmission and reception tasks on the FDD band, whereas during T2, the UE exclusively receives data on the SDL band, adhering to the semi-static switching pattern received from the network. This implementation ensures that the UE can efficiently switch between different operational modes to optimize data throughput and network performance. Additionally, or alternatively, the semi-static switching pattern period 402 illustrated in FIG. 4 may be used to configure the UE to switch between different operating modes. For example, the UE may switch from the FDD band operation mode (case 1) to the SDL band operation mode (case 2) in a recurring manner. This recurring switching pattern helps to balance the UE's communication load and enhance overall network efficiency.

There may be a switching delay and a time mask for carrier switching. The switching delay may be 1, 2, or 3 OFDM symbols depending on UE capability. During the switching delay, Tx/Rx on FDD band and Rx on SDL band may be dropped if scheduled by the network entity.

For semi-static switching patterns where the UE toggles between different operational states (e.g., Tx/Rx on FDD band PCell and Rx on the SDL band SCell) based on predefined time periods (e.g., T1 and T2), a semi-static pattern may not align with the periodic signals and channels that UEs are required to receive or measure, such as SSBs, TRSs, and CSI-RS. The misalignment between the semi-static switching pattern and the periodic reception of these signals can lead to a scenario where the UE needs to receive or measure signals in a band that it is not currently tuned to, according to the switching pattern.

The need for the UE to receive or measure periodic signals in both the FDD and SDL bands further complicates the issue. SSB or TRS reception is crucial for downlink synchronization and Doppler/Power Delay Profile (PDP) estimation, while channel measurement resource (CMR) and interference measurement resource (IMR) reception are necessary for CSI reporting, which includes CQI, PMI, and rank indicator (RI) reporting. Furthermore, semi-persistent scheduling (SPS)-PDSCH reception must also be considered. There is a greater issue if the periodic signals for the SDL band are configured within the T1 period of the switching pattern, which is designated for the FDD band.

As indicated above, FIG. 4 is provided as an example. Other examples may differ from what is described with regard to FIG. 4.

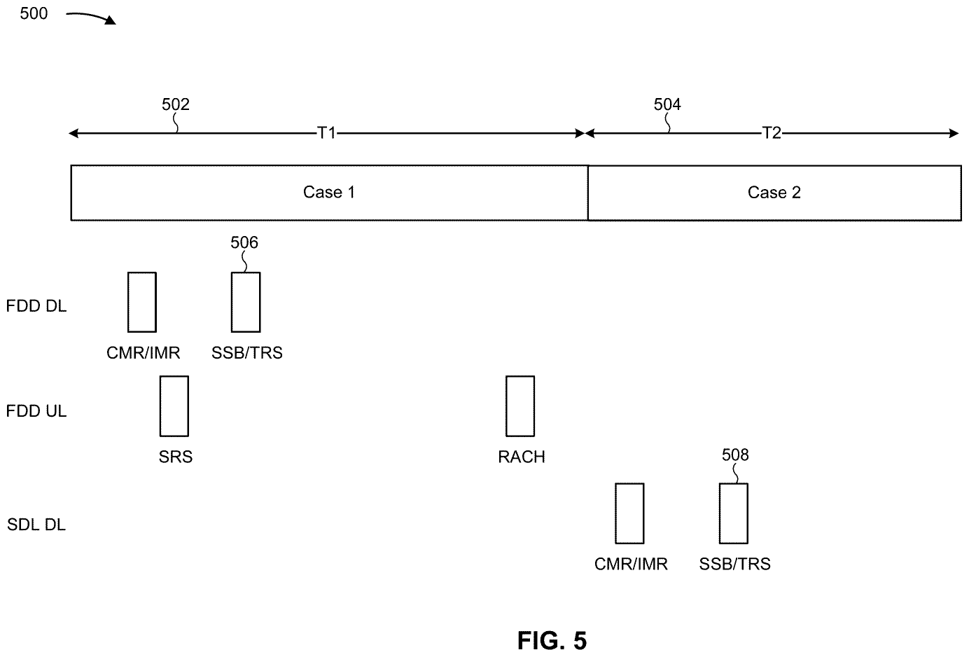

FIG. 5 is a diagram illustrating an example 500 of using a switching pattern for signal reception.

In some aspects, the UE may ensure effective and efficient communication in systems utilizing LB-LB CA with Rx switching. The synchronization between the UE and the network entity avoids conflicts and ensures that both entities have a consistent understanding of the UE's expected behavior during periods of switching. Additionally, the UE may accommodate scenarios where periodic signals and semi-static switching patterns are not aligned, providing a mechanism for the UE to handle such collisions without compromising signal reception or system performance.

According to various aspects described herein, a UE may utilize LB-LB CA with Rx switching. The UE may receive a first configuration to operate in a first mode (e.g., case 1) for transmission and reception in the FDD band during a first time period (e.g., T1). The UE may also receive a second configuration to operate in a second mode (e.g., case 2) for reception in the SDL during a second time period (e.g., T2), where reception in the FDD band is allowed or dropped during the second time period based at least in part on a rule. In some aspects, dropped reception may include suspended reception. The UE may receive an indication of a semi-static switching pattern that defines transition between the first mode and the second mode. The UE may then receive downlink signals according to the rule and the semi-static switching pattern. The semi-static switching pattern may govern transitions between these operational modes. The UE may process downlink signals according to a specified rule and the semi-static switching pattern.

In some aspects, the UE may determine a semi-static switching pattern by an RRC configuration, and the UE may receive configurations for handling periodic downlink signals such as SSBs, TRSs, CSI-RSs, or SP-PDSCH messages. The rule may specify whether periodic downlink signals for the SDL band are to be aligned with the semi-static switching pattern or if the signals are allowed to be non-aligned, with potential reception of SDL band signals during periods designated for FDD band operation. The UE's capability to adapt to the semi-static switching pattern for the reception of periodic downlink signals aligns with the network's scheduling constraints, thereby optimizing the utilization of radio resources.

In some aspects, the UE's capability to switch to the SDL band for signal reception or measurement without interrupting the semi-static switching pattern potentially conserves processing resources and memory resources by avoiding unnecessary signal reception attempts during non-designated periods. Additionally, network-directed control of SP-PDSCH reception can prevent scheduling conflicts and enhance the efficiency of resource allocation, which may contribute to improved network capacity and conservation of network resources.

Advantages may include enhanced radio resource management, prevention of scheduling conflicts, and improved network capacity through controlled UE behavior in LB-LB CA systems with Rx switching. This approach conserves processing resources, memory resources, and network resources, contributing to a more efficient wireless communication system.

As shown by example 500, a UE may switch between different modes during respective time periods defined by a switching pattern in a staggered semi-static signal/channel configuration. For example, the switching pattern period may include a first time period (T1) 502 and a second time period (T2) 504. As shown in FIG. 5, during T1, the UE may operate in Case 1 mode, where the UE is configured to transmit and receive in an FDD band. In this mode, the UE may handle tasks such as CMR/IMR reception and synchronization SSB/TRS 506 reception for the FDD downlink (DL). Additionally, the UE may manage sounding reference signals (SRSs) transmission for the FDD uplink (UL). For a staggered periodic signal/channel configuration, the configuration may be aligned with the semi-static switching pattern.

In some aspects, during T1, the UE may receive a first configuration to operate in a first mode (Case 1) for transmission and reception in FDD band during a first time period (T1). This first configuration allows the UE to perform tasks such as reception of CMR/IMR and reception of SSB/TRS 506 for the FDD downlink. Additionally, or alternatively, during T1, the UE may perform tasks such as handling SRSs for the FDD uplink. For example, the UE may manage SRS transmission to maintain uplink channel quality measurements.

During T2, the UE may transition to Case 2 mode, where the UE is configured to receive in the SDL band only, while transmission and reception in the FDD band are paused. In this mode, the UE may handle tasks such as reception of CMR/IMR and reception of SSB/TRS 508 for the SDL downlink. The switching pattern period may repeat, defining transitions between Case 1 and Case 2 modes based on the semi-static switching pattern received from a network entity.

In some aspects, during T2, the UE may receive a second configuration to operate in a second mode for reception in the SDL band during a second time period T2. This configuration ensures that the UE pauses FDD band transmission and reception and performs tasks such as reception of CMR/IMR and reception of SSB/TRS 508 for the SDL downlink. Additionally, or alternatively, during T2, the UE may receive periodic downlink signals for the SDL band, including SSBs, TRSs, CSI-RSs, or a SP-PDSCH. For example, the UE may receive SSBs to maintain synchronization with the network during SDL reception.

As indicated above, FIG. 5 is provided as an example. Other examples may differ from what is described with regard to FIG. 5.

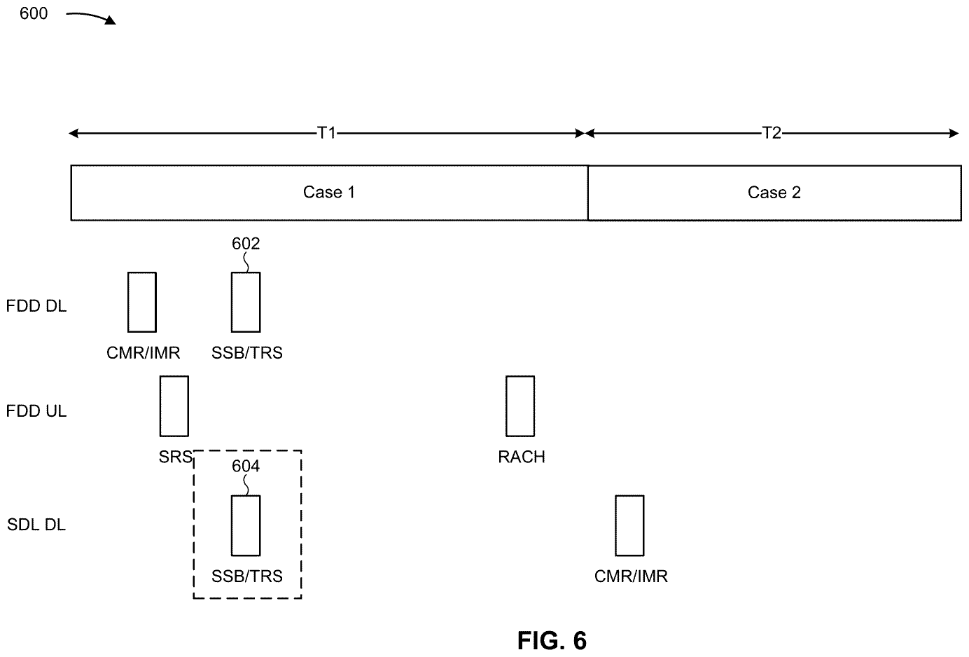

FIG. 6 is a diagram illustrating an example 600 of using a non-staggered configuration.

As shown by FIG. 6, and reference number 600, a configuration may define a semi-static switching pattern T1 and T2 for a UE to operate in different modes during respective time periods. This operation may include a non-staggered periodic signal/channel configuration, where the periodic DL signal/channel (SSB/TRS/CSI-RS/IMR, SPS-PDSCH) for the FDD band is configured within T1 of the switching pattern, and at least one of periodic DL signal (SSB/TRS/CSI-RS/IMR) for the SDL band is configured within T1. For a non-staggered periodic signal/channel configuration, the configuration may not be aligned with the semi-static switching pattern.

For example, during T1, the UE may operate in Case 1 mode, where the UE transmits and receives in the FDD band. The UE may handle signal reception for FDD DL CMR/IMR and SSB/TRS 602, as well as FDD UL SRSs.

In some aspects, during T1, the UE may perform FDD DL reception of SSB/TRSs 602. For example, the UE may perform synchronization and TRS measurements for maintaining proper timing and frequency synchronization with the network. Additionally, or alternatively, during T1, the UE may receive FDD DL CMR/IMR. For instance, the UE may engage in measuring channel quality and interference levels to assist in optimizing the communication link. Additionally, or alternatively, during T1, the UE may receive FDD UL SRS. For example, the UE may transmit SRSs to enable the network to estimate the uplink channel quality for scheduling and link adaptation purposes. The UE may also be configured to receive an SDL DL SSB/TRS 604. DL and UL operation in FDD band are suspended if the UE switches to the SDL band to receive the SSB/TRS 604.

During T2, the UE may switch to Case 2 mode, where the UE only receives in the SDL band, handling tasks such as CMR/IMR reception, while suspending transmission and reception in the FDD band. During T2, the UE may receive SDL DL CMR/IMR. For instance, the UE may perform channel and interference measurements in the supplementary downlink band to ensure optimal reception quality.

As indicated above, FIG. 6 is provided as an example. Other examples may differ from what is described with regard to FIG. 6.

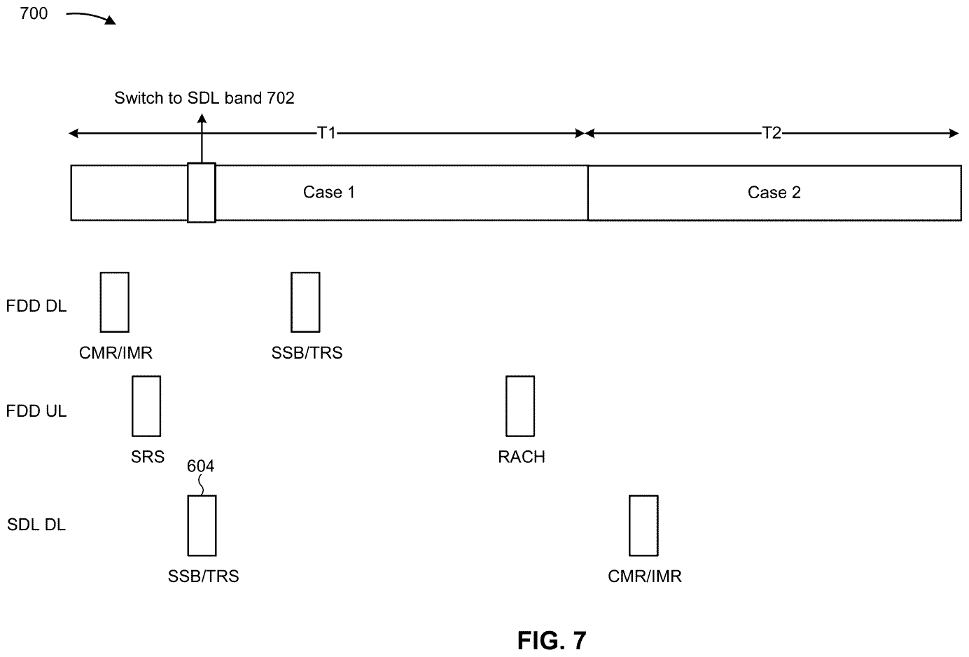

FIG. 7 is a diagram illustrating an example 700 of a first option for a non-staggered periodic signal/channel configuration.

The UE behavior (configured by the network entity) for reception of a first periodic signal/channel within the T1 period may include a first option, where the rule specifies that the UE is expected to switch to the SDL band (shown by 702) to receive/measure the periodic signal/channel (e.g., SSB/TRS 604) within a T1 period for every occasion of the periodic signal. DL and UL operation in FDD band are suspended as the UE switches to the SDL band.

As indicated above, FIG. 7 is provided as an example. Other examples may differ from what is described with regard to FIG. 7.

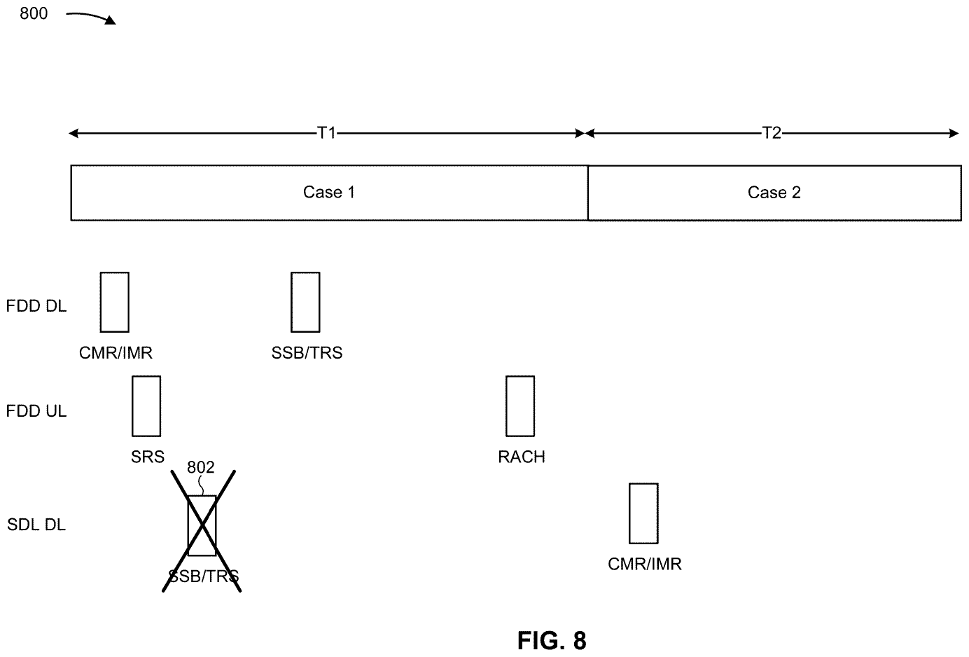

FIG. 8 is a diagram illustrating an example 800 of a second option for the non-staggered periodic signal/channel configuration.

The UE behavior for reception of the first periodic signal/channel within the T1 period may include a second option, where the rule specifies that the UE is expected to drop reception of the periodic signal/channel (shown by 802) of the SDL band within the T1 period for every occasion of the periodic signal/channel.

As indicated above, FIG. 8 is provided as an example. Other examples may differ from what is described with regard to FIG. 8.

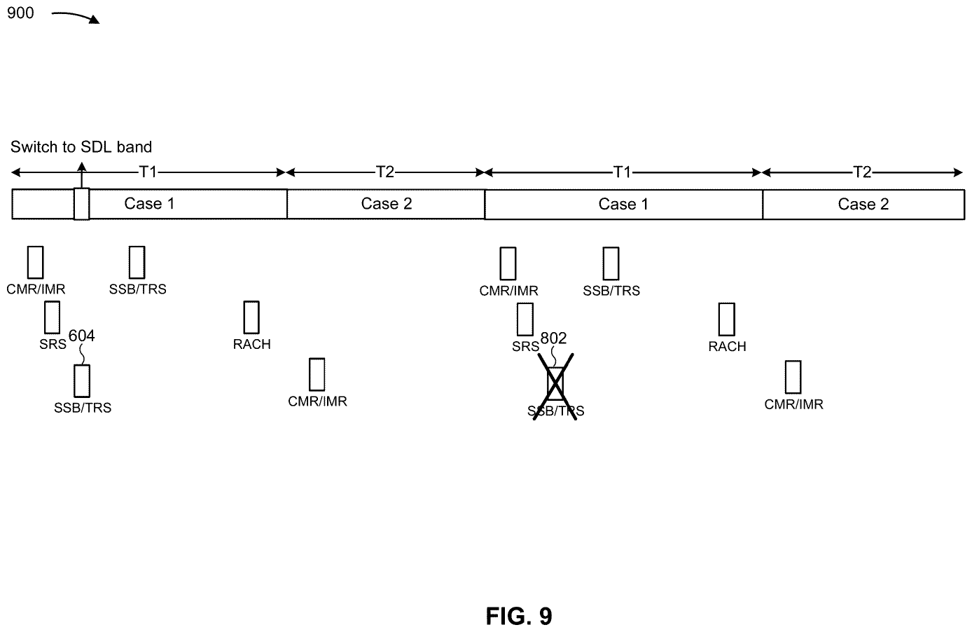

FIG. 9 is a diagram illustrating an example 900 of a third option for the non-staggered periodic signal/channel configuration.

The UE behavior for reception of the first periodic signal/channel within the T1 period may include a third option, where the rule specifies that the UE is expected to switch to the SDL band to receive/measure the periodic signal/channel within the T1 period on K occasions in every N occasions of periodic signal/channel, where (K, N) is configured by the network entity, and K<N. That is, the K occasions in every N occasions may be a configured subset of occasions.

In some aspects, the network entity may configure different options for different signal/channels for periodic signal/channel reception of the SDL band within the T1 time period. For example, for SSB/TRS, the network entity may configure any of the three options. If option 1 is configured, the UE may measure the SSB/TRS for DL synchronization, PDP/Doppler estimation, and radio link management (RLM) as in legacy. If option 2 is configured, the UE may not rely on SSB/TRS in the SDL band for DL synchronization and PDP/Doppler estimation of the SDL band SCell. In this case, the network entity may configure a reference signal on another serving cell as a quasi-co-location (QCL) reference for the PDCCH/PDSCH reception on SDL band SCell (cross-CC QCL). If option 3 is configured, the UE may measure the SSB/TRS for DL synchronization, PDP/Doppler estimation, and RLM at a reduced rate (SSB/TRS periodicity is effectively extended by a factor of N).

For CMR/IMR for CSI reporting, the network entity may configure either option 1 or option 3. If option 1 is configured, the UE may measure CSI as in legacy. If option 3 is configured, the UE may measure CSI at a reduced rate (CMR/IMR periodicity is effectively extended by a factor of N).

For SPS-PDSCH, the specification may not allow SPS-PDSCH configuration for the SDL band within the T1 period. Alternatively, the specification may allow SPS-PDSCH configuration for the SDL band across the T1 and T2 time periods. In some aspects, SPS-PDSCH occasions within the T1 period may be expected to be invalid occasions. The UE may drop reception of the periodic signal at invalid occasions. Alternatively, the SPS-PDSCH occasions within the T1 period may be expected to be valid occasions. The UE may be expected to switch to SDL band for reception of SPS-PDSCH within the T1 period. The network entity may configure UE behavior between the alternatives via an RRC configuration for SPS-PDSCH.

FIG. 9 is provided as an example. Other examples may differ from what is described with regard to FIG. 9.

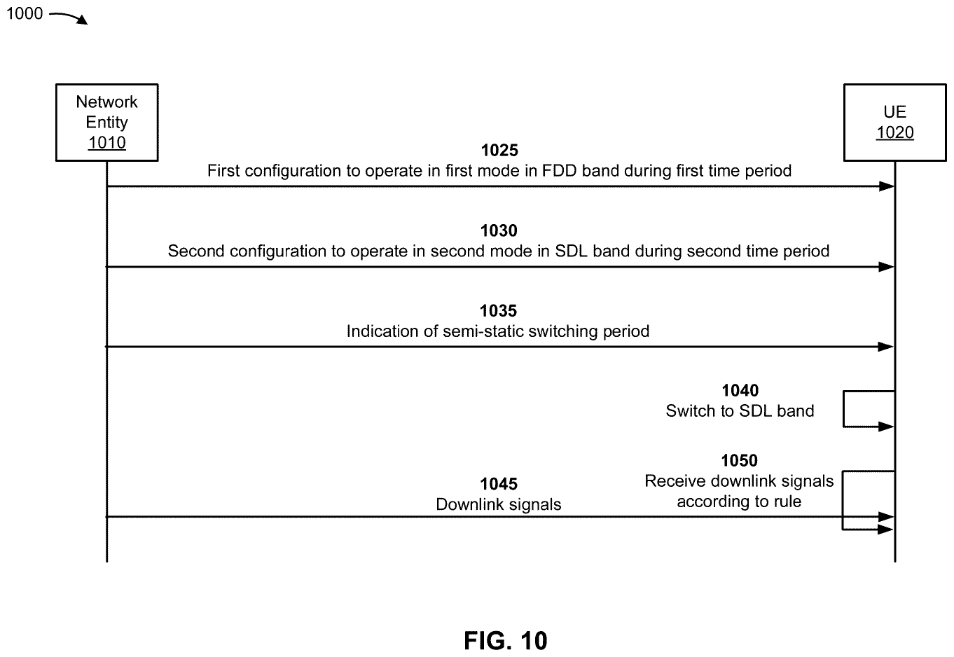

FIG. 10 is a diagram illustrating an example 1000 associated with using a switching pattern. As shown in FIG. 10, a network entity 1010 (e.g., network node 110) and a UE 1020 (e.g., UE 120) may communicate with one another.

As shown by reference number 1025, the network entity 1010 may transmit configurations for the UE 1020 to operate in different modes during respective time periods. For example, the network entity 1010 may transmit a first configuration for the UE 1020 to operate in a first mode (e.g., Case 1) in the FDD band during a first time period (e.g., T1), and a second configuration, as shown by reference number 1030, for the UE 1020 to operate in a second mode (e.g., Case 2) in the SDL band during a second time period (e.g., T2). Additionally, the network entity 1010 may transmit an indication of a semi-static switching period, as shown by reference number 1035, that defines transitions between the first and second modes. The UE 1020 may switch to the SDL band, as shown by reference number 1040, and receive downlink signals according to the rule and the semi-static switching pattern, as shown by reference numbers 1045 and 1050.

In some aspects, the first configuration may be for SSB/TRSs, CSI-RSs, or an SP-PDSCH. For example, these signals may be configured to ensure the UE 1020 maintains synchronization and performs necessary channel measurements.

Additionally, or alternatively, the second configuration may indicate periodic downlink signals for the SDL band are configured to be aligned with the semi-static switching pattern. For instance, the periodic signals may occur during the designated SDL band operation periods, facilitating a seamless transition between the first and second modes.

Additionally, or alternatively, the network entity 1010 may transmit a configuration where the rule specifies that periodic downlink signals are configured to be non-aligned with the semi-static switching pattern, and periodic downlink signals for the SDL band is configured within the first time period. For example, periodic downlink signals for the SDL band may occur during the FDD band operation period, requiring the UE 1020 to adapt its operations accordingly. By coordinating reception of downlink signals involved in a switching pattern, the UE may more efficiently receive signals and avoid delays. As a result, throughput is increased.

As indicated above, FIG. 10 is provided as an example. Other examples may differ from what is described with respect to FIG. 10.

FIG. 11 is a diagram illustrating an example process 1100 performed, for example, at a UE or an apparatus of a UE. Example process 1100 is an example where the apparatus or the UE (e.g., UE 1020) performs operations associated with using a switching pattern for signal reception.

As shown in FIG. 11, in some aspects, process 1100 may include receiving a first configuration to operate in a first mode for transmission and reception in FDD band during a first time period (block 1110). For example, the UE (e.g., using reception component 1302 or communication manager 1306, depicted in FIG. 13) may receive a first configuration to operate in a first mode for transmission and reception in FDD band during a first time period, as described above.

As further shown in FIG. 11, in some aspects, process 1100 may include receiving a second configuration to operate in a second mode for reception in a supplementary downlink band during a second time period, where reception in the FDD band is allowed or dropped during the second time period based at least in part on a rule (block 1120). For example, the UE (e.g., using reception component 1302 or communication manager 1306, depicted in FIG. 13) may receive a second configuration to operate in a second mode for reception in a supplementary downlink band during a second time period, where reception in the FDD band is allowed or dropped during the second time period based at least in part on a rule, as described above.

As further shown in FIG. 11, in some aspects, process 1100 may include receiving an indication of a semi-static switching pattern that defines transition between the first mode and the second mode (block 1130). For example, the UE (e.g., using reception component 1302 or communication manager 1306, depicted in FIG. 13) may receive an indication of a semi-static switching pattern that defines transition between the first mode and the second mode, as described above.

As further shown in FIG. 11, in some aspects, process 1100 may include receiving downlink signals according to the rule and the semi-static switching pattern (block 1140). For example, the UE (e.g., using reception component 1302 or communication manager 1306, depicted in FIG. 13) may receive downlink signals according to the rule and the semi-static switching pattern, as described above.

Process 1100 may include additional aspects, such as any single aspect or any combination of aspects described below or in connection with one or more other processes described elsewhere herein.

In a first aspect, the semi-static switching pattern is semi-static and is determined by an RRC configuration.

In a second aspect, alone or in combination with the first aspect, wherein the downlink signals include periodic downlink signals for the supplementary downlink band, and receiving periodic downlink signals for the supplementary downlink band include receiving at least one of SSBs, TRSs, CSI-RSs, or a SP-PDSCH.

In a third aspect, alone or in combination with one or more of the first and second aspects, the rule specifies that periodic downlink signals for the SDL band are configured to be aligned with the semi-static switching pattern. For example, a periodic DL signal/channel (e.g., SSB/TRS/CSI-RS/IMR, SPS-PDSCH) and a periodic UL signal/channel (e.g., SRS, RACH) for the FDD band may be configured within a T1 period of a switching pattern. In another example, a periodic DL signal/channel (e.g., SSB/TRS/CSI-RS/IMR, SPS-PDSCH) for the SDL band may be configured within a T2 period of a switching pattern. Reception of a periodic signal in both FDD and SDL band does not collide with a switching duration between the FDD and SDL bands.

In a fourth aspect, alone or in combination with one or more of the first through third aspects, the rule specifies that periodic downlink signals are configured to be non-aligned with the semi-static switching pattern, and the periodic downlink signals for the SDL band are configured within the first time period.

In a fifth aspect, alone or in combination with one or more of the first through fourth aspects, process 1100 includes switching to the supplementary downlink band to receive or measure the periodic downlink signals within the first time period for every occasion of the periodic downlink signals. This may be associated with the first option for non-staggered signals described in connection with FIG. 7.

In a sixth aspect, alone or in combination with one or more of the first through fifth aspects, the rule specifies dropping reception of the periodic downlink signals for every occasion of the periodic downlink signals within the first time period. This may be associated with the second option for non-staggered signals described in connection with FIG. 8.

In a seventh aspect, alone or in combination with one or more of the first through sixth aspects, process 1100 includes switching to the SDL band to receive or measure the periodic downlink signals within the first time period on a configured subset of occasions. This may be associated with the third option for non-staggered signals described in connection with FIG. 9. For example, the UE may be expected to switch to the SDL band to receive/measure periodic signal/channel within the T1 period on the K-th occasion in every N occasions of periodic signal/channel where (K, N) is configured by the network entity. Any of the three options may be configured for SSB/TRS. The first and third options may be configured for CMR/IMR.

Two alternatives may be used for SPS-PDSCG. In an eighth aspect for a first alternative, alone or in combination with one or more of the first through seventh aspects, the second configuration does not allow for SP-PDSCH reception for the SDL band in the first time period. For example, SPS-PDSCH occasions within the T1 period are assumed to be invalid occasions. In a ninth aspect, alone or in combination with one or more of the first through eighth aspects, the rule specifies that the UE is to expect SP-PDSCH occasions within the first time period to be invalid occasions.

In a tenth aspect for a second alternative, alone or in combination with one or more of the first through eighth aspects, the second configuration configures SP-PDSCH reception for the SDL band across the first time period and the second time period. For example, SPS-PDSCH occasions within the T1 period are assumed to be valid occasions. The UE is expected to switch to the SDL band for reception of the SPS-PDSCH within the T1 period. The network entity may configure UE behavior between the two alternatives via RRC configuration for SPS-PDSCH.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network entity or an apparatus of a network entity. Example process 1200 is an example where the apparatus or the network entity (e.g., network entity 1010) performs operations associated with using a switching pattern for signal reception.

As shown in FIG. 12, in some aspects, process 1200 may include transmitting a first configuration for a UE to operate in a first mode for transmission and reception in FDD band during a first time period (block 1210). For example, the network entity (e.g., using transmission component 1404 or communication manager 1406, depicted in FIG. 14) may transmit a first configuration for a UE to operate in a first mode for transmission and reception in FDD band during a first time period, as described above.

As further shown in FIG. 12, in some aspects, process 1200 may include transmitting a second configuration for the UE to operate in a second mode for reception in an SDL band during a second time period, where the second configuration indicates that reception by the UE in the FDD band is allowed or dropped during the second time period based at least in part on a rule (block 1220). For example, the network entity (e.g., using transmission component 1404 or communication manager 1406, depicted in FIG. 14) may transmit a second configuration for the UE to operate in a second mode for reception in an SDL band during a second time period, where the second configuration indicates that reception by the UE in the FDD band is allowed or dropped during the second time period based at least in part on a rule, as described above.

As further shown in FIG. 12, in some aspects, process 1200 may include transmitting an indication of a semi-static switching pattern that defines transition between the first mode and the second mode (block 1230). For example, the network entity (e.g., using transmission component 1404 or communication manager 1406, depicted in FIG. 14) may transmit an indication of a semi-static switching pattern that defines transition between the first mode and the second mode, as described above.

As further shown in FIG. 12, in some aspects, process 1200 may include transmitting downlink signals according to the rule and the semi-static switching pattern (block 1240). For example, the network entity (e.g., using transmission component 1404 or communication manager 1406, depicted in FIG. 14) may transmit downlink signals according to the rule and the semi-static switching pattern, as described above.

Process 1200 may include additional aspects, such as any single aspect or any combination of aspects described below or in connection with one or more other processes described elsewhere herein.

In a first aspect, the semi-static switching pattern is semi-static and is determined by an RRC configuration.

In a second aspect, alone or in combination with the first aspect, wherein the downlink signals include periodic downlink signals for the supplementary downlink band, and receiving periodic downlink signals for the SDL band include receiving at least one of SSBs, TRSs, CSI-RSs, or a SP-PDSCH.

In a third aspect, alone or in combination with one or more of the first and second aspects, the rule specifies that periodic downlink signals for the SDL band are configured to be aligned with the semi-static switching pattern.

In a fourth aspect, alone or in combination with one or more of the first through third aspects, the rule specifies that periodic downlink signals are configured to be non-aligned with the semi-static switching pattern, and the periodic downlink signals for the SDL band are configured within the first time period.

In a fifth aspect, alone or in combination with one or more of the first through fourth aspects, the rule specifies dropping reception of the periodic downlink signal for every occasion of the periodic downlink signals within the first time period.

In a sixth aspect, alone or in combination with one or more of the first through fifth aspects, the second configuration does not allow for SP-PDSCH reception for the SDL band in the first time period.

In a seventh aspect, alone or in combination with one or more of the first through sixth aspects, the second configuration configures SP-PDSCH reception for the SDL band across the first time period and the second time period.

In an eighth aspect, alone or in combination with one or more of the first through seventh aspects, the rule specifies that the UE is to expect SP-PDSCH occasions within the first time period to be invalid occasions.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 1-10. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive a first configuration to operate in a first mode for transmission and reception in FDD band during a first time period. The reception component 1302 may receive a second configuration to operate in a second mode for reception in an SDL band during a second time period, where reception in the FDD band is allowed or dropped during the second time period based at least in part on a rule. The reception component 1302 may receive an indication of a semi-static switching pattern that defines transition between the first mode and the second mode. The reception component 1302 may receive downlink signals according to the rule and the semi-static switching pattern.

The communication manager 1306 may switch to the SDL band to receive or measure the periodic downlink signals within the first time period for every occasion of the periodic downlink signals. The communication manager 1306 may switch to the SDL band to receive or measure the periodic downlink signals within the first time period on a configured subset of occasions.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network entity, or a network entity may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 1406 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network entity.

In some aspects, the apparatus 1400 may be configured to perform one or more operations described herein in connection with FIGS. 1-10. Additionally, or alternatively, the apparatus 1400 may be configured to perform one or more processes described herein, such as process 1200 of FIG. 12. In some aspects, the apparatus 1400 or one or more components shown in FIG. 14 may include one or more components of the network entity described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network entity described above in connection with FIG. 1, such as a radio, one or more RF chains, one or more transceivers, or one or more modems, each of which may in turn be coupled with one or more antennas of the network entity.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit a first configuration for a UE to operate in a first mode for transmission and reception in FDD band during a first time period. The transmission component 1404 may transmit a second configuration for the UE to operate in a second mode for reception in a supplementary downlink band during a second time period, where reception by the UE in the FDD band is allowed or dropped during the second time period based at least in part on a rule. The transmission component 1404 may transmit an indication of a semi-static switching pattern that defines transition between the first mode and the second mode. The transmission component 1404 may transmit downlink signals according to the rule and the semi-static switching pattern.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving a first configuration to operate in a first mode for transmission and reception in a frequency division duplex (FDD) band during a first time period; receiving a second configuration to operate in a second mode for reception in a supplementary downlink band during a second time period, wherein reception in the FDD band is allowed or dropped during the second time period based at least in part on a rule; receiving an indication of a semi-static switching pattern that defines transition between the first mode and the second mode; and receiving downlink signals according to the rule and the semi-static switching pattern.

Aspect 2: The method of Aspect 1, wherein the semi-static switching pattern is semi-static and is determined by a radio resource control configuration.

Aspect 3: The method of any of Aspects 1-2, wherein the downlink signals include periodic downlink signals for the supplementary downlink band, and wherein the periodic downlink signals for the supplementary downlink band include at least one of synchronization signal blocks, tracking reference signals, channel state information reference signals, or a semi-persistent physical downlink shared channel (SP-PDSCH).

Aspect 4: The method of any of Aspects 1-3, wherein the rule specifies that periodic downlink signals for the supplementary downlink band are configured to be aligned with the semi-static switching pattern.

Aspect 5: The method of any of Aspects 1-4, wherein rule specifies that periodic downlink signals are configured to be non-aligned with the semi-static switching pattern, and the periodic downlink signals for the supplementary downlink band are configured within the first time period.

Aspect 6: The method of Aspect 5, further comprising switching to the supplementary downlink band to receive or measure the periodic downlink signals within the first time period for every occasion of the periodic downlink signals.

Aspect 7: The method of Aspect 5, wherein the rule specifies dropping reception of the periodic downlink signals for every occasion of the periodic downlink signals within the first time period.

Aspect 8: The method of Aspect 5, further comprising switching to the supplementary downlink band to receive or measure the periodic downlink signals within the first time period on a configured subset of occasions.

Aspect 9: The method of Aspect 5, wherein the second configuration does not allow for SP-PDSCH reception for the supplementary downlink band in the first time period.

Aspect 10: The method of Aspect 5, wherein the second configuration configures SP-PDSCH reception for the supplementary downlink band across the first time period and the second time period.

Aspect 11: The method of Aspect 10, wherein the rule specifies that the UE is to expect SP-PDSCH occasions within the first time period to be invalid occasions.

Aspect 12: A method of wireless communication performed by a network entity, comprising: transmitting a first configuration for a user equipment (UE) to operate in a first mode for transmission and reception in a frequency division duplex (FDD) band during a first time period; transmitting a second configuration for the UE to operate in a second mode for reception in a supplementary downlink band during a second time period, wherein reception by the UE in the FDD band is allowed or dropped during the second time period based at least in part on a rule; transmitting an indication of a semi-static switching pattern that defines transition between the first mode and the second mode; and transmitting downlink signals according to the rule and the semi-static switching pattern.

Aspect 13: The method of Aspect 12, wherein the semi-static switching pattern is semi-static and is determined by a radio resource control configuration.

Aspect 14: The method of any of Aspects 12-13, wherein the downlink signals include periodic downlink signals for the supplementary downlink band, and wherein periodic downlink signals for the supplementary downlink band include at least one of synchronization signal blocks, tracking reference signals, channel state information reference signals, or a semi-persistent physical downlink shared channel (SP-PDSCH).

Aspect 15: The method of any of Aspects 12-14, wherein the rule specifies that periodic downlink signals for the supplementary downlink band are configured to be aligned with the semi-static switching pattern.

Aspect 16: The method of any of Aspects 12-15, wherein rule specifies that periodic downlink signals are configured to be non-aligned with the semi-static switching pattern, and the periodic downlink signals for the supplementary downlink band are configured within the first time period.

Aspect 17: The method of Aspect 16, wherein the rule specifies dropping reception of the periodic downlink signals for every occasion of the periodic downlink signals within the first time period.

Aspect 18: The method of Aspect 16, wherein the second configuration does not allow for SP-PDSCH reception for the supplementary downlink band in the first time period.

Aspect 19: The method of Aspect 16, wherein the second configuration configures SP-PDSCH reception for the supplementary downlink band across the first time period and the second time period.

Aspect 20: The method of Aspect 19, wherein the rule specifies that the UE is to expect SP-PDSCH occasions within the first time period to be invalid occasions.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive a first configuration to operate in a first mode for transmission and reception in a frequency division duplex (FDD) band during a first time period;
receive a second configuration to operate in a second mode for reception in a supplementary downlink band during a second time period, wherein reception in the FDD band is allowed or dropped during the second time period based at least in part on a rule;
receive an indication of a semi-static switching pattern that defines transition between the first mode and the second mode; and
receive downlink signals according to the rule and the semi-static switching pattern.

2. The UE of claim 1, wherein the semi-static switching pattern is semi-static and is determined by a radio resource control configuration.

3. The UE of claim 1, wherein the downlink signals include periodic downlink signals for the supplementary downlink band, and wherein the processing system, to cause the UE to receive the periodic downlink signals, is configured to cause the UE to receive signal blocks, tracking reference signals, channel state information reference signals, or a semi-persistent physical downlink shared channel (SP-PDSCH).

4. The UE of claim 1, wherein the rule specifies that periodic downlink signals for the supplementary downlink band are configured to be aligned with the semi-static switching pattern.

5. The UE of claim 1, wherein the rule specifies that periodic downlink signals are configured to be non-aligned with the semi-static switching pattern, and the periodic downlink signals for the supplementary downlink band are configured within the first time period.

6. The UE of claim 5, wherein the processing system is configured to cause the UE to switch to the supplementary downlink band to receive or measure the periodic downlink signals within the first time period for every occasion of the periodic downlink signals.

7. The UE of claim 5, wherein the rule specifies dropping reception of the periodic downlink signals for every occasion of the periodic downlink signals within the first time period.

8. The UE of claim 5, wherein the processing system is configured to cause the UE to switch to the supplementary downlink band to receive or measure the periodic downlink signals within the first time period on a configured subset of occasions.

9. The UE of claim 5, wherein the second configuration does not allow for SP-PDSCH reception for the supplementary downlink band in the first time period.

10. The UE of claim 5, wherein the second configuration configures SP-PDSCH reception for the supplementary downlink band across the first time period and the second time period.

11. The UE of claim 10, wherein the rule specifies that the UE is to expect SP-PDSCH occasions within the first time period to be invalid occasions.

12. The UE of claim 5, wherein the processing system is configured to cause the UE to use a reference signal on another serving cell as a quasi co-location (QCL) reference for physical downlink control channel (PDCCH) and/or physical downlink shared channel (PDSCH) reception on a secondary cell of the supplementary downlink band.

13. A network entity, comprising:
a processing system that includes one or more processors and one or more code-storing memories coupled with the one or more processors, the processing system configured to cause the network entity to:
transmit a first configuration for a user equipment (UE) to operate in a first mode for transmission and reception in a frequency division duplex (FDD) band during a first time period;
transmit a second configuration for the UE to operate in a second mode for reception in a supplementary downlink band during a second time period, wherein reception by the UE in the FDD band is allowed or dropped during the second time period based at least in part on a rule;
transmit an indication of a semi-static switching pattern that defines transition between the first mode and the second mode; and
transmit downlink signals according to the rule and the semi-static switching pattern.

14. The network entity of claim 13, wherein the semi-static switching pattern is semi-static and is determined by a radio resource control configuration.

15. The network entity of claim 13, wherein the downlink signals include periodic downlink signals for the supplementary downlink band, and wherein the processing system, to cause the network entity to transmit periodic downlink signals for the supplementary downlink band, is configured to cause the network entity to transmit signal blocks, tracking reference signals, channel state information reference signals, or a semi-persistent physical downlink shared channel (SP-PDSCH).

16. The network entity of claim 13, wherein the rule specifies that periodic downlink signals for the supplementary downlink band are configured to be aligned with the semi-static switching pattern.

17. The network entity of claim 13, wherein rule specifies that periodic downlink signals are configured to be non-aligned with the semi-static switching pattern, and the periodic downlink signals for the supplementary downlink band are configured within the first time period.

18. The network entity of claim 17, wherein the rule specifies dropping reception of the periodic downlink signals for every occasion of the periodic downlink signals within the first time period.

19. The network entity of claim 17, wherein the second configuration does not allow for SP-PDSCH reception for the supplementary downlink band in the first time period.

20. The network entity of claim 17, wherein the second configuration configures SP-PDSCH reception for the supplementary downlink band across the first time period and the second time period.

21. The network entity of claim 20, wherein the rule specifies that the UE is to expect SP-PDSCH occasions within the first time period to be invalid occasions.

22. The network entity of claim 17, wherein the processing system is configured to cause the network entity to configure the UE to use a reference signal on another serving cell as a quasi co-location (QCL) reference for physical downlink control channel (PDCCH) and/or physical downlink shared channel (PDSCH) reception on a secondary cell of the supplementary downlink band.

23. A method for wireless communication at a user equipment (UE), comprising:
receiving a first configuration to operate in a first mode for transmission and reception in a frequency division duplex (FDD) band during a first time period;
receiving a second configuration to operate in a second mode for reception in a supplementary downlink band during a second time period, wherein reception in the FDD band is allowed or dropped during the second time period based at least in part on a rule;
receiving an indication of a semi-static switching pattern that defines transition between the first mode and the second mode; and
receiving downlink signals according to the rule and the semi-static switching pattern.

24. The method of claim 23, wherein the rule specifies that periodic downlink signals are configured to be non-aligned with the semi-static switching pattern, and the periodic downlink signals for the supplementary downlink band are configured within the first time period.

25. The method of claim 24, wherein the rule specifies dropping reception of the periodic downlink signals for every occasion of the periodic downlink signals within the first time period.

26. The method of claim 24, wherein the second configuration configures semi-persistent physical downlink shared channel (SP-PDSCH) reception for the supplementary downlink band across the first time period and the second time period, and wherein the rule specifies that the UE is to expect SP-PDSCH occasions within the first time period to be invalid occasions.

27. The method of claim 24, further comprising using a reference signal on another serving cell as a quasi co-location (QCL) reference for physical downlink control channel (PDCCH) and/or physical downlink shared channel (PDSCH) reception on a secondary cell of the supplementary downlink band.

28. A method for wireless communication at a network entity, comprising:
transmitting a first configuration for a user equipment (UE) to operate in a first mode for transmission and reception in a frequency division duplex (FDD) band during a first time period; and
transmitting a second configuration for the UE to operate in a second mode for reception in a supplementary downlink band during a second time period, wherein reception by the UE in the FDD band is allowed or dropped during the second time period based at least in part on a rule.

29. The method of claim 28, wherein the rule specifies dropping reception of periodic downlink signals for every occasion of the periodic downlink signals within the first time period.

30. The method of claim 28, wherein the second configuration configures semi-persistent physical downlink shared channel (SP-PDSCH) reception for the supplementary downlink band across the first time period and the second time period, and wherein the rule specifies that the UE is to expect SP-PDSCH occasions within the first time period to be invalid occasions.
